(19) United States
(12) Patent Application Publication
(10) Pub. No.: US 2004/0015975 A1
(43) Pub. Date: Jan. 22, 2004

(54) Interface for distributed processing framework system

(75) Inventors: Murali K. Nandigama, San Jose, CA (US); Uday S. Dhanikonda, San Jose, CA (US); Madhava Avvari, Cupertino, CA (US); Philip Chin, San Jose, CA (US)

Correspondence Address: BEYER WEAVER & THOMAS LLP, P.O. BOX 778, BERKELEY, CA, 94704-0778, US

(73) Assignee: Sun Microsystems, Inc.

(21) Appl. No.: 10/125,239

(22) Filed: Apr. 17, 2002

(51) Int. Cl. G06F 9/00

(52) U.S. Cl. 718/104

(57) ABSTRACT

An interface for a distributed processing framework (DPF) is disclosed. The distributed processing framework (DPF) can manage the execution of a process utilizing cross-platform dynamically networked distributed computer system. The interface to the distributed processing framework (DPF) can be implemented as a graphical user interface. The graphical user interface allows users to conveniently communicate with the distributed processing framework. The graphical user interface can provide users with customized menus. Accordingly, the user can conveniently make selections and submit a request for processing.

### CROSS REFERENCE TO RELATED APPLICATIONS

This application is related to U.S. Provisional Patent Application No. 60/304,919 entitled “Distributed Test Framework,” filed Jul. 11, 2001, which is hereby incorporated herein by reference in its entirety.

This application is also related to U.S. patent application Ser. No. 09/953,223 entitled “Distributed Processing Framework System,” filed Sep. 11, 2001, which is hereby incorporated herein by reference in its entirety.

### BACKGROUND OF THE INVENTION

1. Field of the Invention

The present invention relates generally to software processing, and more particularly, to methods and systems for intelligently and automatically selecting and utilizing networked computer resources to collectively process computing operations.

2. Description of the Related Art

As the use of software in performing daily tasks is increasing rapidly, assessing software reliability through software testing has become an imperative stage in the software development cycle. As is well known, software testing is used to find and eliminate defects (i.e., bugs) in software, which, if undetected, can cause the software to operate improperly. In general, software testing may be performed by implementing a stand-alone computer or a network of computer resources. When a stand-alone computer system is used to perform the software testing, the stand-alone computer system is programmed to run a test selected by the software user. Comparatively, if a network of computer resources is used, the user is responsible for manually adding and deleting the computer resources to the network, programming the master computer system and the server, initiating the running of a user-selected test, and running the test on the group of dedicated computer systems coupled to the server.

In either scenario, a heavy user interface is required for initiating the software testing on the master computer, scheduling the running of the specific test on the system resources, adding and deleting of the system resources, keeping track of the system resources and their respective hardware and software configuration, and maintaining the system resources. Additionally, in either case, the software testing is performed by dedicated system resources. That is, the system resources are designed to solely be used for software testing.

At least two drawbacks can be associated with the current state of software testing described above. First, the significant role of human interaction causes software testing to be very time consuming and costly. In certain situations, this setback is extrapolated as a result of human error. Second, currently, computer resources are being wasted, as the computer resources are solely dedicated to software testing.

In view of the foregoing, there is a need for a flexible methodology and system capable of selecting and utilizing dynamic, cross-platform computer resources to process a computer software.

### SUMMARY OF THE INVENTION

Broadly speaking, the invention pertains to an interface for a distributed processing framework (DPF). The distributed processing framework (DPF) can manage the execution of a process utilizing a cross-platform dynamically networked distributed computer system. The interface to the distributed processing framework (DPF) can be implemented as a graphical user interface. As will be appreciated, the graphical user interface allows users to conveniently communicate with the distributed processing framework (DPF). The graphical user interface can provide the users with customized menus. Accordingly, the user can conveniently make selections and submit a request for processing by using the graphical user interface.

The invention can be implemented in numerous ways, including as a method, an apparatus, a computer readable medium, and a database system. Several embodiments of the invention are discussed below.

As a computing environment, one embodiment of the invention includes a processing system and an interface. The processing system includes a master system configured to execute a service component and a system controller component, and a processing resource configured to register with a look up service of the service component for a specific period of time, the registering being configured to advertise the eligibility of the processing resource to execute a software processing job having a set of requirements, wherein the system controller component is configured to search the look up service of the service component to locate the processing resource having a set of attributes substantially matching the set of requirements of the software processing job. The processing interface is capable of communicating with the processing system and providing the processing system with one or more requirements of the set of requirements.

As a method for testing a software component in a distributed testing system, one embodiment of the invention includes the acts of: displaying a graphical user interface to the distributed testing system; receiving through the graphical user interface a request to test a software component; determining whether the graphical user interface should be customized for the request; customizing the interface based on the request when it is determined that the interface should be customized for said request; and displaying the customized interface.

As a computer readable media including computer program code, one embodiment of the invention provides a processing interface capable of communicating with a processing system and providing the processing system with one or more requirements of a set of requirements. The processing system includes:

a master system configured to execute a service component and a system controller component, and a processing resource configured to register with a look up service of the service component for a specific period of time, the registering being configured to advertise the eligibility of the processing resource to execute a software processing job having a set of requirements, wherein the system controller component is configured to search the look up service of the service component to locate the processing resource having a set of attributes substantially matching the set of requirements of the software processing job.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A represents a computing environment in accordance with one embodiment of the invention.

FIG. 1B illustrates a block diagram of a distributed test framework (DTF) system in accordance with one embodiment of the invention.

FIG. 2 illustrates a distributed processing interface in accordance with one embodiment of the invention.

FIG. 3 illustrates a method for generating a set of test requirements which can be used to test software components in a distributed testing system in accordance with one embodiment of the invention.

FIGS. 4A-L illustrate a graphical user interface for a distributed processing framework in accordance with one embodiment of the invention.

### DETAILED DESCRIPTION OF THE PREFERRED EMBODIMENTS

The invention pertains to an interface for a distributed processing framework (DPF). The distributed processing framework (DPF) can manage the execution of a process utilizing a cross-platform dynamically networked distributed computer system. The interface to the distributed processing framework (DPF) can be implemented as a graphical user interface. As will be appreciated, the graphical user interface allows users to conveniently communicate with the distributed processing framework. The graphical user interface can provide the users with customized menus. Accordingly, the user can conveniently make selections and submit a request for processing by using the graphical user interface.

It should be noted that the distributed processing framework (DPF) has the capability to intelligently select and utilize computer systems of an ad-hoc network of distributed computer systems having either the same or different software/hardware configurations to execute a process. As used herein, an “ad-hoc” or a “dynamic” network is defined as a network in which the computer resources may be part of the network temporarily and for a specific length of time (i.e., spontaneous). In one example, the DPF system of the present invention implements the Jini™ (hereinafter “Jini”) technology to provide spontaneous interaction between its components. In this manner, the computer systems attach to and detach from the ad-hoc network of processing resources (e.g., computer resources) without disturbing the DPF system. Accordingly, the computer resources are not limited to executing processes submitted to the DPF system.

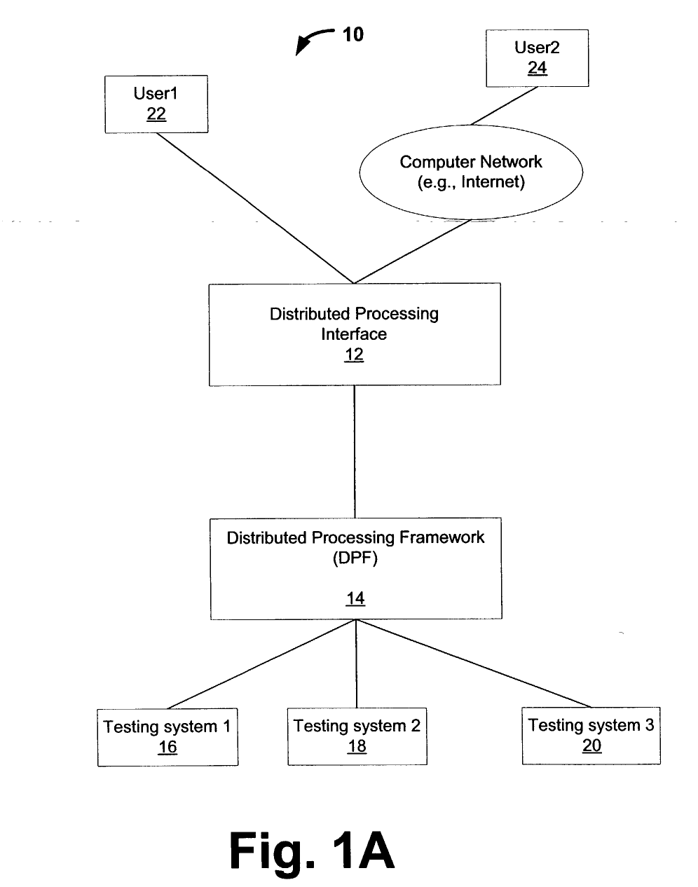

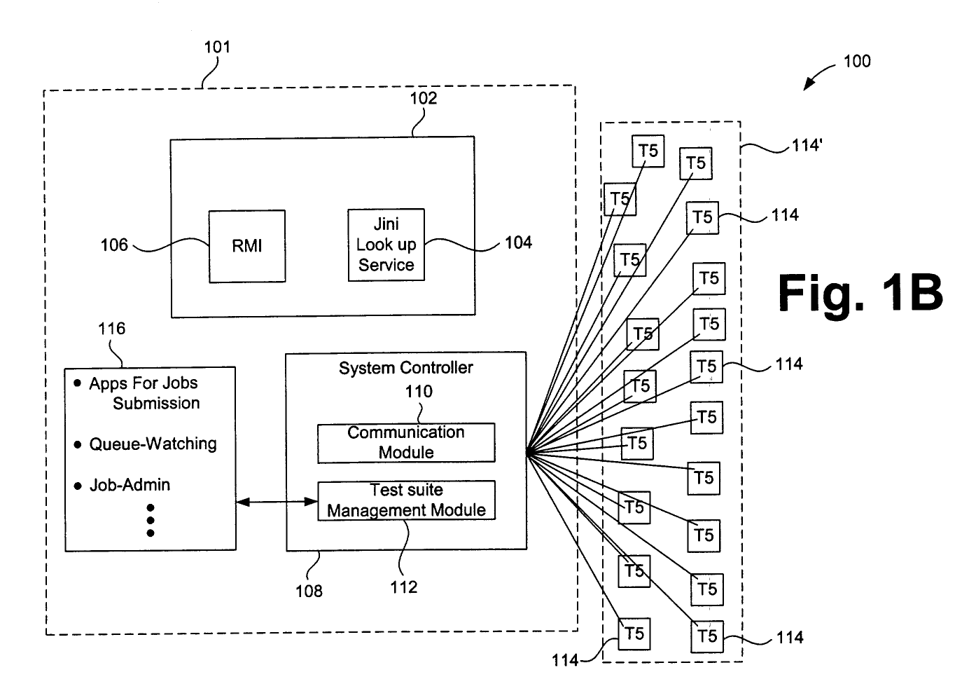

FIG. 1A represents a computing environment 10 in accordance with one embodiment of the invention. The computing environment 10 includes a distributed processing interface 12 and a distributed processing framework (DPF) 14. In the described embodiment, the DPF system 14 is a distributed test framework (DTF) 14 system configured to manage test suite execution on cross-platform dynamically networked computer systems. As such, the distributed test framework (DTF) 14 can be used to test software on one or more of the testing systems 16, 18 and 20. As will be appreciated, the distributed processing interface 12 provides an interface to the distributed processing framework (DPF) 14. This means that the distributed processing interface 12 can be used to communicate with the distributed processing framework (DPF) 14. By way of example, a user (e.g., user 22 or 24) can use the distributed processing interface 12 to specify a set of testing requirements. Based on the testing requirements, the distributed processing framework (DPF) 14 can then schedule the testing on one or more appropriate testing machines (e.g., testing system 16, 18 or 20).

It should be noted that in one implementation, the DTF system 14 is a server computer system and a plurality of ad-hoc networks of processing resources configured to spontaneously interact implementing the Jini technology. The server computer system is configured to include a Jini look up service and a system controller configured to manage the processing of the submitted test suites. In one instance, the plurality of computer resources join the Jini look up service registering their respective proxies and the corresponding attributes. In one example, the system controller searches the look up service for an available suitable computer resource to process each of the submitted test suites. Once a computer resource is selected to run the test suite, the machine service component of the selected computer resource spawns a second service (e.g., process service) to execute the test suite.

As one embodiment of the present invention can be implemented using the Jini technology, a brief introduction to Jini is provided below. Nevertheless, this brief introduction to Jini should not be considered as limiting as Jini technology is well known by those skilled in the art. Jini technology is a network architecture that enables the spontaneous assembly and interaction of services and devices on a network of computer systems. Built on the Java platform, Jini technology eliminates the challenges of scale, component integration, and ad-hoc networking encountered in distributed computing environments. Jini simplifies interactions over a network by providing a fast and easy way for clients to use available services. Jini technology is also configured to be wire-protocol and transport-protocol neutral.

Summarily, Jini network technology includes a communication and programming model that enables clients and Jini services to discover and connect with each other to form an impromptu (i.e., spontaneous) Jini community. As Jini is written in Java, Jini implements the mechanism, Java Remote Method Invocation Application Program Interface (API), to move objects around the network.

In one embodiment, a Jini service is configured to employ a proxy to move around the network. As used herein, the proxy is defined as an object having service attributes and communication instructions. Through implementing discovery and join processes, the Jini services are found and thereafter registered with a look up service on a network. As used herein, registering a service is defined as sending the service proxy to all look up services on the network or a selected subset of the look up services. By way of example, the look up service is equivalent to a directory or an index of available services wherein the proxies for each of the services and their associated code are stored. When a service is requested, the proxy associated with the requested service is sent to the requesting client, thus enabling the client to use the requested service. Once dispatched, the proxy is configured to conduct all communication between the client and the Jini service.

In providing an ad-hoc network of computers, in one embodiment, Jini introduces a concept called “leasing.” That is, once a service joins the Jini network, the Jini service registers its availability for a certain period of leased time. This lease period may be renegotiated before the lease time is expired. When a service leaves the Jini network, the service entry in the look up service is removed automatically once the service's lease is expired. For further details on Jini technology, please refer to K. Arnold et al., The Jini Specification (1999) and W. Keith Edwards, Core Jini (1999).

As Jini is implemented in the Java™ (hereinafter “Java”) programming language, in a like manner, an overview of Java is provided below. In operation, a user of a typical Java-based system interacts with an application layer of a system generally written by a third party developer. The application layer generally provides the user interface for the system. A Java module is used to process commands received by the application layer. A Java virtual machine is used as an interpreter to provide portability to Java applications. In general, developers design Java applications as hardware-independent software modules, which are executed Java virtual machines. The Java virtual machine layer is developed to operate in conjunction with the native operating system of a particular hardware, which represents the physical hardware on which the system operates or runs. In this manner, Java applications can be ported from one hardware device to another without requiring updating of the application code.

Unlike most programming languages in which a program is compiled into machine-dependent, executable program code, Java classes are compiled into machine-independent byte code class files which are executed by a machine-dependent virtual machine. The virtual machine provides a level of abstraction between the machine independence of the byte code classes and the machine-dependent instruction set of the underlying computer hardware. A class loader is responsible for loading the byte code class files as needed, and an interpreter or just-in-time compiler provides for the transformation of byte codes into machine code.

More specifically, Java is a programming language designed to generate applications that can run on all hardware platforms, small, medium and large, without modification. Developed by Sun Microsystems, Inc. of Palo Alto, Calif., Java has been promoted and geared heavily for the Web, both for public Web sites and intranets. Generally, Java programs can be called from within HTML documents or launched as a standalone. When a Java program runs from a Web page, it is called a “Java applet,” and when run on a Web server, the application is called a “servlet.”

Java is an interpreted language. The source code of a Java program is compiled into an intermediate language called “byte code.” The byte code is then converted (interpreted) into machine code at runtime. Upon finding a Java applet, the Web browser invokes a Java interpreter (Java Virtual Machine), which translates the byte code into machine code and runs it. Thus, Java programs are not dependent on any specific hardware and will run in any computer with the Java Virtual Machine software. On the server side, Java programs can also be compiled into machine language for faster performance. However, a compiled Java program loses hardware independence as a result.

Keeping these brief overviews to Jini and Java as they relate to the present invention in mind, reference is now made to FIG. 1B, illustrating a block diagram of a distributed test framework (DTF) system 100, in accordance with one embodiment of the present invention. As shown, physically, the DTF system 100 includes two groups of computer systems: (1) a system server group 101, and (2) a test system group 114′. The system server group 101 includes a service component 102 and a system controller 108. The service component 102 is configured to contain a Jini look up service 104 and a Remote Method Invocation (RMI) 106. In one embodiment, the RMI is designed to handle various communication needs. Comparatively, the Jini look up service 104 is a dedicated process running on the master computer system server, and is configured to function as a central registry. As used herein, the master computer system is defined as the computer system running the system controller 108. As designed, in one embodiment, the master computer is configured to include both the system controller 108 and the service component 102. However, in a different implementation, each of the system controller 108 and the service component 102 may be included and run by separate computer systems. As designed, the look up service 104 is configured to enable the system controller 108 to locate available computer systems of an ad-hoc network of computer systems to execute a given test execution request using the test system registerable attributes. For instance, the look up service 104 includes registerable attributes which identify the test machine platform, operating system, and other software and hardware characteristics.

The illustrated system controller 108 includes a communication module 110 and a test suite management module 112. The communication module 110 manages the communication between the system controller 108 and the distributed test systems 114. For instance, the communication module 110 is responsible for locating available test systems 114, running test execution requests and gathering information regarding the status of the test systems 114. In one example, the system controller 108 manages the communication with the distributed test systems 114 by implementing a plurality of threads. In this manner, the system controller 108 has the capability to communicate with a plurality of test systems 114 in parallel. However, it must be noted that in a different embodiment, the system controller 108 may implement any suitable mechanism to manage the communication between the system controller 108 and the distributed test systems 114 (e.g., Jini, RMI, TCP/IP Sockets, etc.).

The test suite management module 112 is responsible for managing the processing of the submitted test suites and the test execution requests. As used herein, a test suite is a comprehensive list of data files having commands specifically programmed to initiate a number of functional aspects of the software product being tested. For instance, if the software product being tested is a word processing program, the test suite may activate a spell check command, a cut test command, a paste command, etc. Thus, once the test suite is executed, the test results reveal whether any of the tested commands failed to operate as intended. Also as used herein, once submitted for processing, each test suite becomes a “test execution request.” As the processing of different portions of the test suite can be assigned to different test machines, the test suites may be divided into a plurality of test execution requests (i.e., jobs).

By way of example, the test suite management module 112 maintains an inqueue directory designed to include almost all the submitted test execution requests. Once the system controller 108 is initiated, the system controller 108 is configured to read each test execution request from files held in the inqueue directory. Once a test execution request is read, it is put into either a wait queue configured to hold test execution requests waiting to be executed or an execution queue designed to hold test execution requests currently being executed. Further information regarding managing the inqueue directory, wait queue, and execution queue will be provided below. As illustrated in one example, the test suite management module 112 is configured to manage the software applications and user interfaces implemented for job submission, queue watching, job administration, etc., as shown in 116.

The test system group 114 includes a plurality of test systems 114 having similar or diverse hardware and software configurations. Although shown as a group, the test systems 114 are not necessarily limited to testing. In fact, the test systems 114 can be computers or systems used by employees of a company for normal desktop work. So long as the test systems 114 are associated with the networked group, the processing power of these test systems 114 can be used. In one embodiment, the test systems 114 can be used during normal working hours when the test systems 114 are running, for example, business applications, or during off hours, thus tapping into potentially huge processing resources that would otherwise be left unused. It should therefore be appreciated that test systems 114 do not necessarily have to be solely dedicated to testing or processing for the system server group 101.

In one embodiment, the test systems 114 are configured to execute the test execution requests dispatched by the system controller 108. Each of the test systems 114 runs an agent process (not shown in this figure) designed to register the respective test system 114 with the Jini look up service 104. In this manner, the agent process for each test system 114 advertises the availability of the associated test system 114. As will be discussed in further detail below, a machine service component of the agent is used to establish communication between the associated test system 114 and the system controller 108. Specifically by implementing the Jini attributes, the machine service registers the test system 114 characteristics with the Jini look up service 104.

The test system 114 attributes are subsequently used by the system controller 108 to locate a test system 114 suitable to execute a specific test execution request.

While the DTF system 100 of the present invention can physically be divided into two groups, logically, the DTF system 100 of the present invention is comprised of three overall parts: (1) Job submission and other user interfaces; (2) Test scheduler and system controller; and (3) Test execution on remote or local systems.

For the most part, the job submission and other user interfaces component is a job queuing system having a variety of applications and user interfaces. As designed, the job submission component is configured to perform several tasks, such as handling job submission, managing queues, administrating jobs, and administrating the ad-hoc network of the distributed test systems.

By way of example, in one implementation, the user interface may be as follows:

Launch system controller:

In one embodiment, launching the system controller 108 is performed by running an appropriate shell script. As designed, the shell script is configured to launch the Jini and RMI support servers.

Kill system controller:

Finds substantially all the processes, and once found, kills each of the processes individually.

Submit jobs:

Before the system controller 108 is launched, an Extensible Markup Language (XML) formatted test-execution-request file is created in the inqueue directory (e.g., that is preferably part of the test suite management module). In this manner, once the system controller 108 is launched, the system controller 108 scans the inqueue directory, thus entering almost each and every test execution request into the in-queue (the in-queue being an actual queue, as contrasted with the inqueue directory).

Check queue:

In one embodiment, a stopgap Graphical User Interface (GUI) is provided.

Cancel/administer a job:

In one implementation, a stopgap GUI is implemented.

Other administrative tasks:

In one exemplary embodiment, additional user interfaces are included. For instance, in certain cases, the system controller 108 is configured to implement various input files.

The second logical component, the test scheduler and system controller, includes the system controller 108 configured to perform the function of managing the job queues and dispatching the test execution requests to test systems 114 for processing. Thus, the system controller 108 is configured to manage both; the wait queue (i.e., the queue containing the test execution requests waiting to be executed).

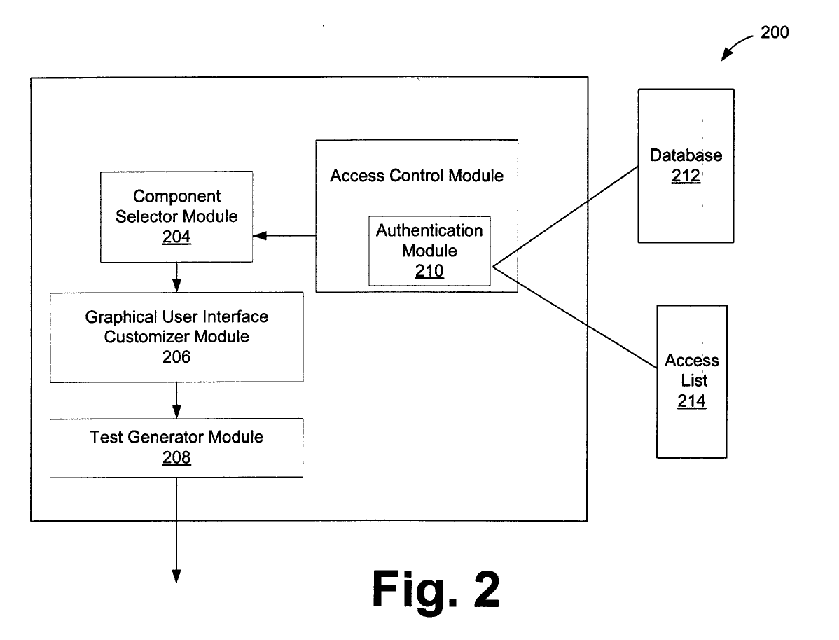

FIG. 2 illustrates a distributed processing interface 200 in accordance with one embodiment of the invention. The distributed processing interface 200 illustrates in greater detail the distributed processing interface 112 of FIG. 1A. As shown in FIG. 2, the distributed processing interface 200 includes an access control module 202, a component select module 204, a graphical user interface customizer module 206, and a test generator module 208. The access control module 202 is capable of controlling access to the distributed processing interface 200. In the described embodiment, the access control module 202 includes an authentication module 210. The authentication module 210 can access a database 212 and an access list 214. As will be appreciated by those skilled in the art, the database 212 and access list can be used by the access control module to determine whether a request to access the distributed processing framework should be granted. If the request is granted, the component selector module 204 can be used by the authentication module 210 to select one or more test requirements. Accordingly, graphical user interface customizer 206 can, for example, be used to generate a customized test screen which is viewed by the user. It should be noted that the access control module 202, component selector module 204 and graphical user interface customizer 206 may generate output at least partially based on input which is provided to the distributed processing interface 200 (e.g., input transmitted by a user). Finally, the test generator module 208 can generate a set of test requirements which can be received as input by a distributed processing framework (e.g., distributed test framework (DTF) system 100 of FIG. 1B).

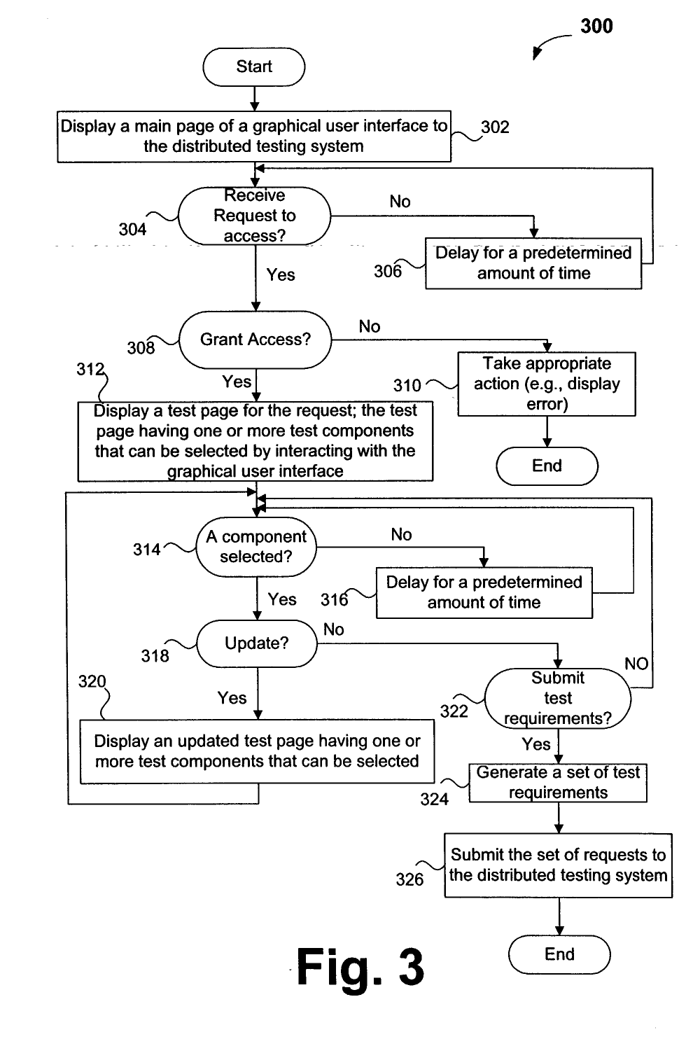

FIG. 3 illustrates a method 300 for generating a set of test requirements which can be used to test software components in a distributed testing system in accordance with one embodiment of the invention. The method 300 can, for example, be performed by distributed processing interface 200 of FIG. 2A. Initially, at operation 302, a main page of a graphical user interface to a distributed testing system is displayed. Next, at operation 304 a determination is made as to whether a request to access the distributed testing system is received. If it is determined at operation 304 that a request is not received, the method 300 proceeds to operation 306 where a delay for a predetermined amount of time is performed before it is again determined at operation 304 whether a request to access the distributed testing system is received.

If it is determined at operation 304 that a request to access the distributed testing system has been received, the method 300 proceeds to operation 308 where a determination is made as to whether access should be granted. If it is determined at operation 308 that access should not be granted, the method 300 proceeds to operation 310 where appropriate action is taken (e.g., an error message can be displayed and/or the graphical user interface can be terminated or the main page can be displayed). The method 300 ends following operation 310.

However, if it is determined at operation 308 that access should be granted, the method 300 proceeds to operation 312 where a test page for the request is displayed. Typically, the test page has one or more test components which can be selected by interacting with the graphical user interface. Accordingly, at operation 314, a determination is made as to whether a component has been selected. If it is determined at operation 314 that a component has not been selected, the method 300 proceeds to operation 316 where a delay for a predetermined amount of time is performed before the method 300 proceeds to operation 314 to determine whether a component has been selected.

On the other hand, if it is determined at operation 314 that a component has been selected, the method 300 proceeds to operation 318 where it is determined whether the test page should be updated based on the selected component. If it is determined at operation 318 that the test page should be updated, the method 300 proceeds to operation 320 where an updated test page having one or more test components which are available for selection is displayed. Thereafter, the method 300 proceeds to operation 314 where a determination is made as to whether a component has been selected. However, if it is determined at operation 318 that the test page should not be updated, the method 300 proceeds to operation 322 where a determination is made as to whether test requirements should be submitted. If it is determined at operation 322 that test requirements should not yet be submitted, the method 300 proceeds to operation 314 where a determination is made as to whether a component has been selected. However, if it determined at operation 320 that the test requirements should be submitted, the method 300 proceeds to operation 324 where a set of test requirements are generated. Accordingly, at operation 326, the set of test requirements are submitted to the distributed testing system. The method 300 ends following operation 326.

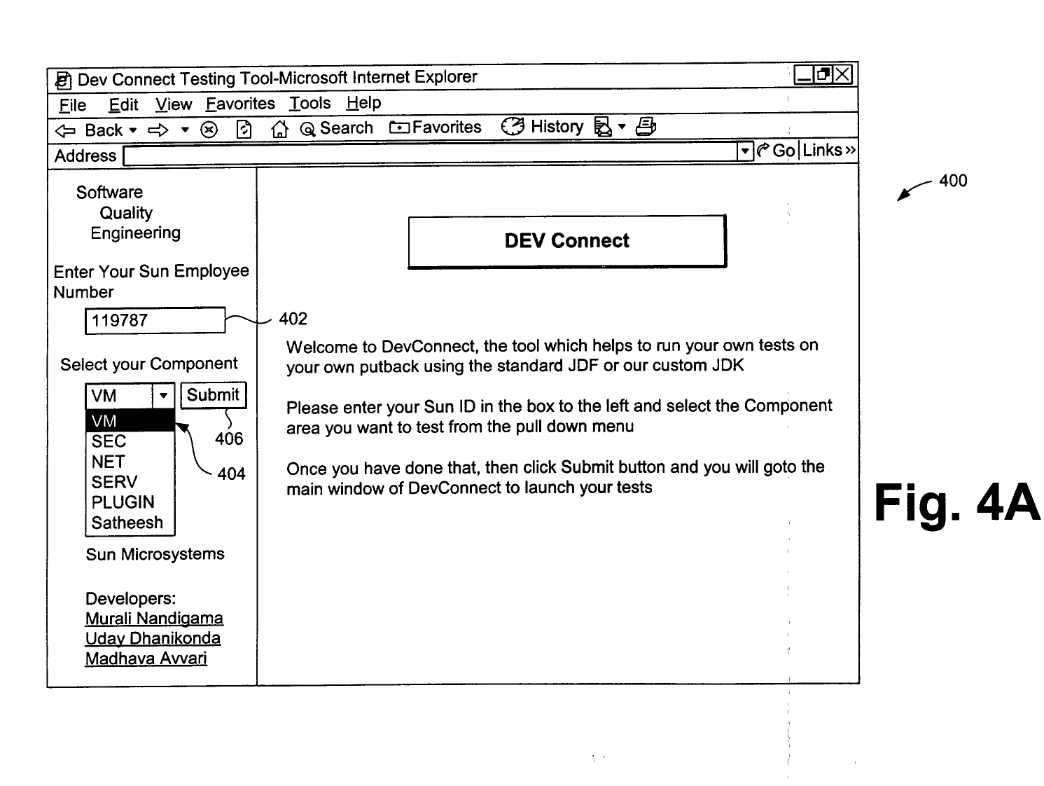

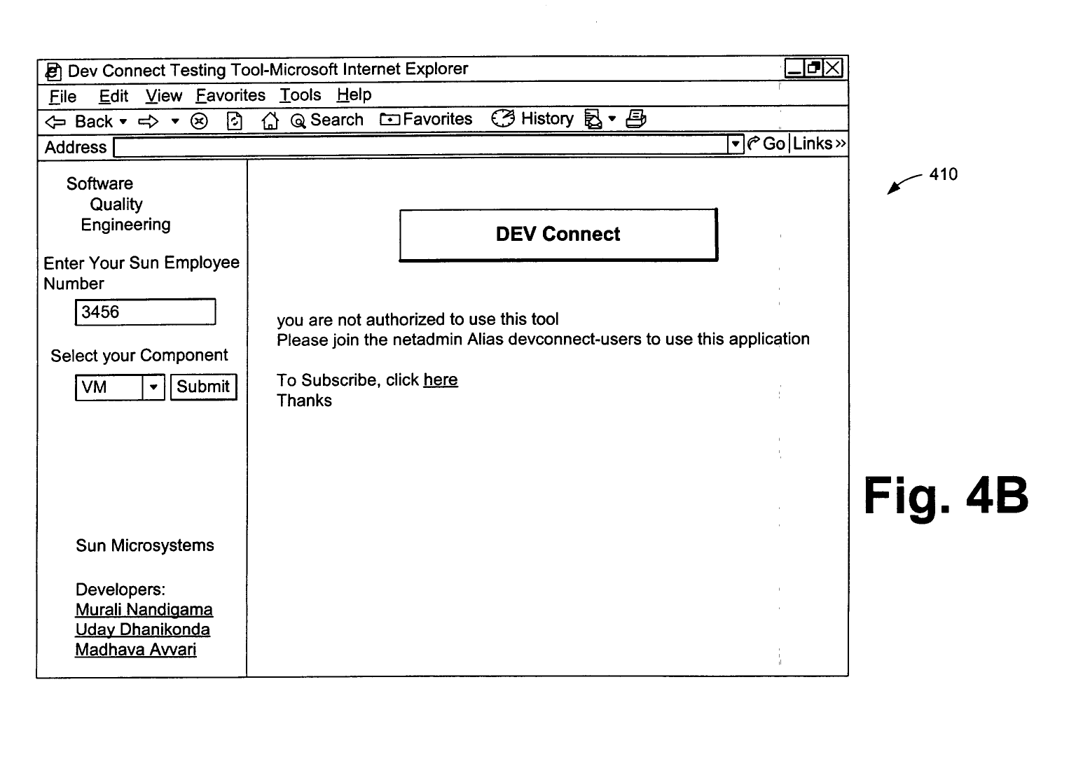

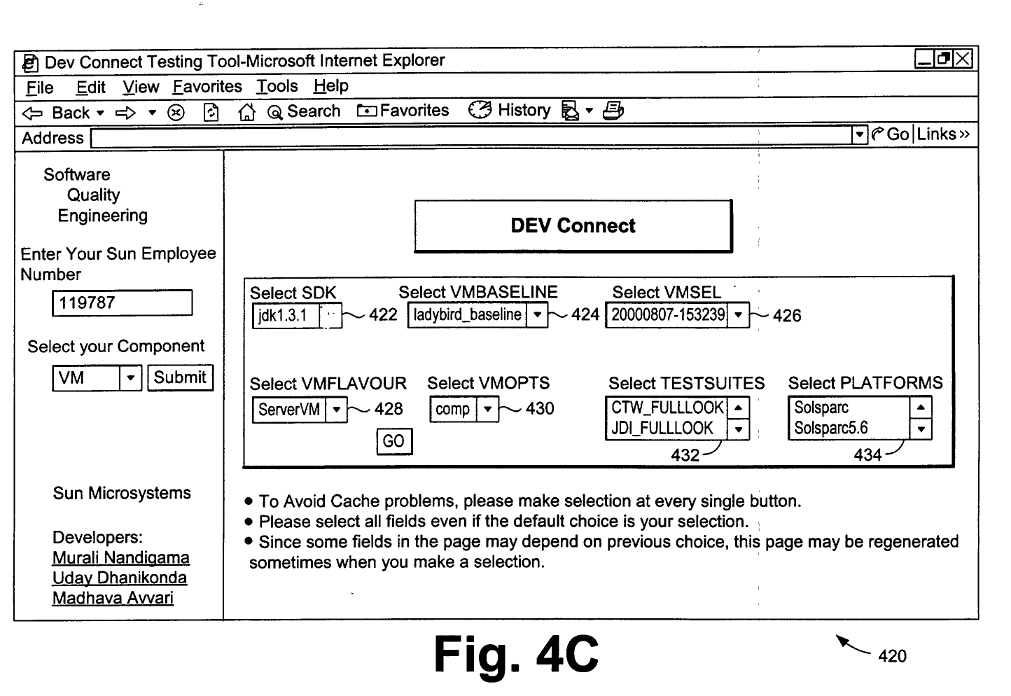

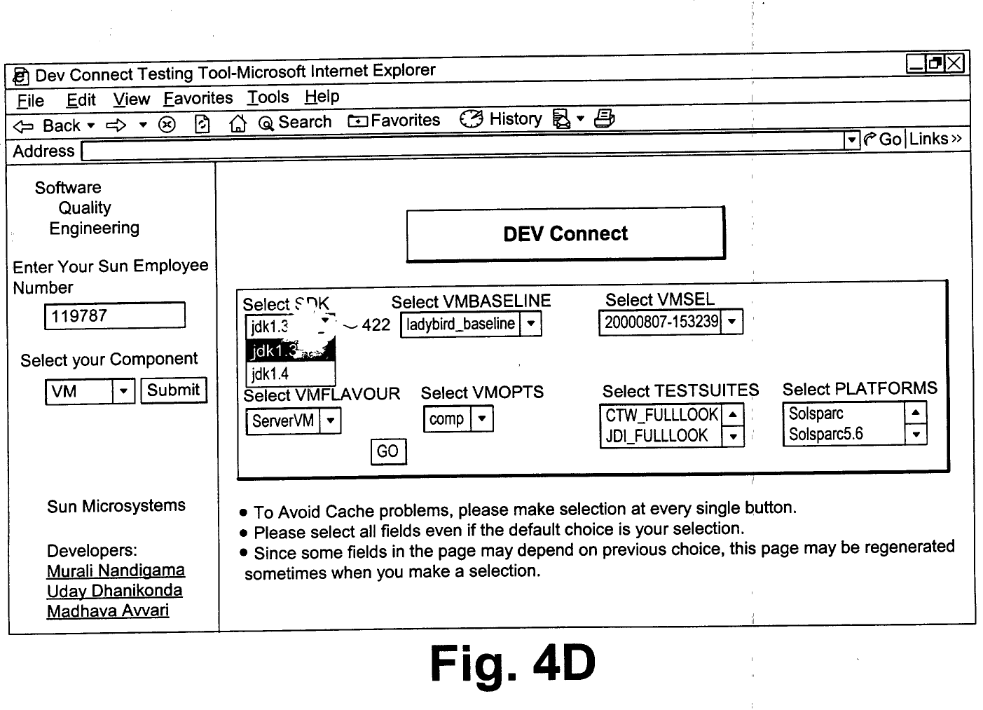

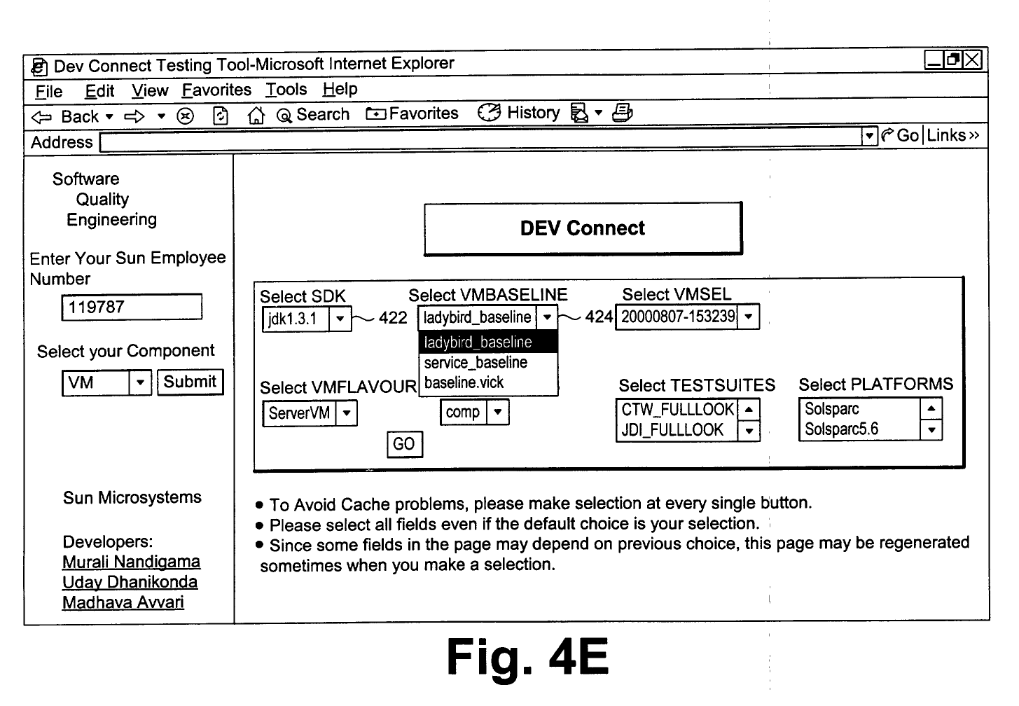

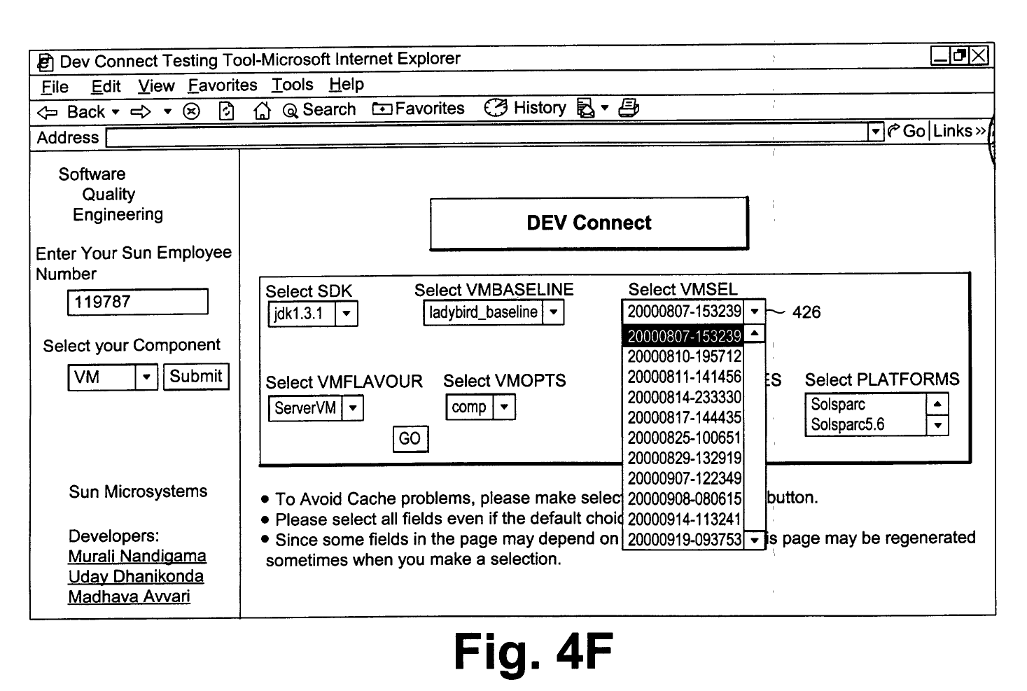

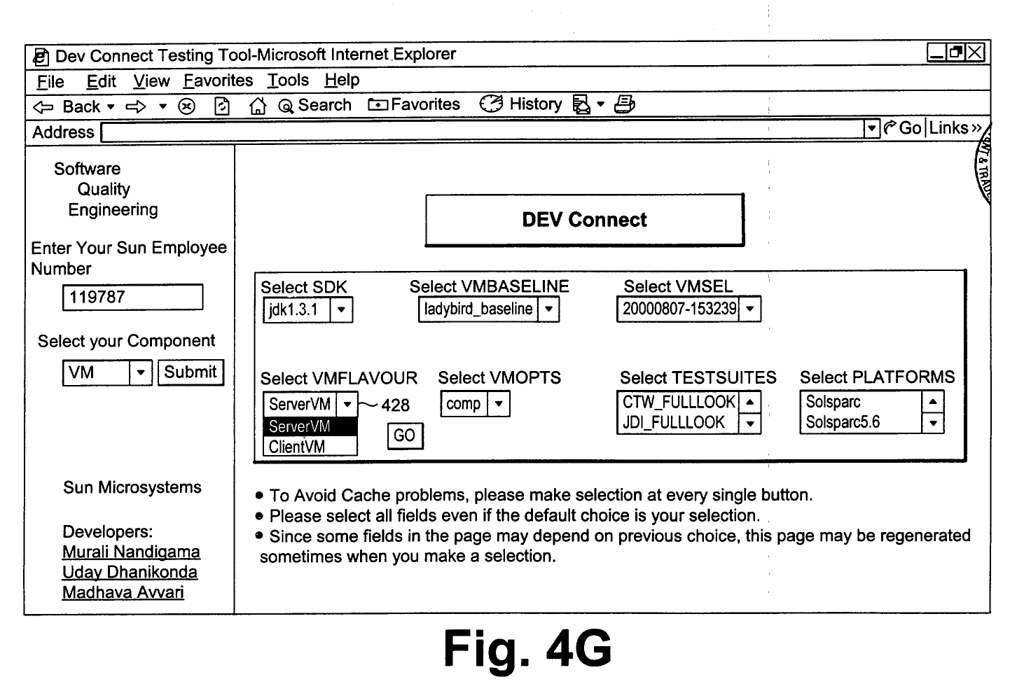

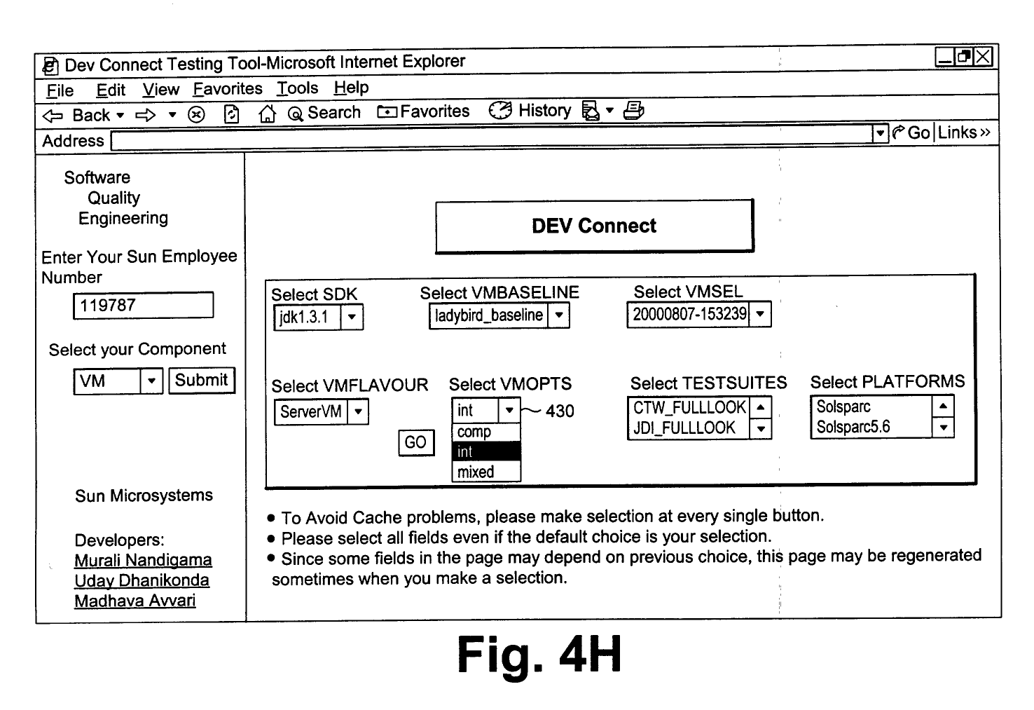

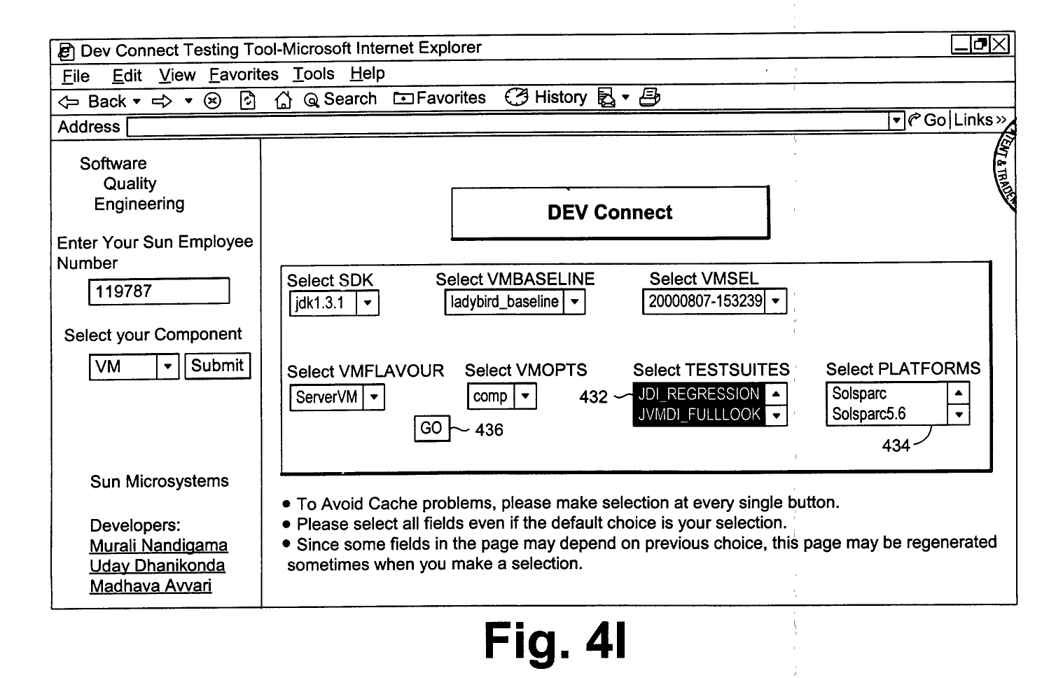

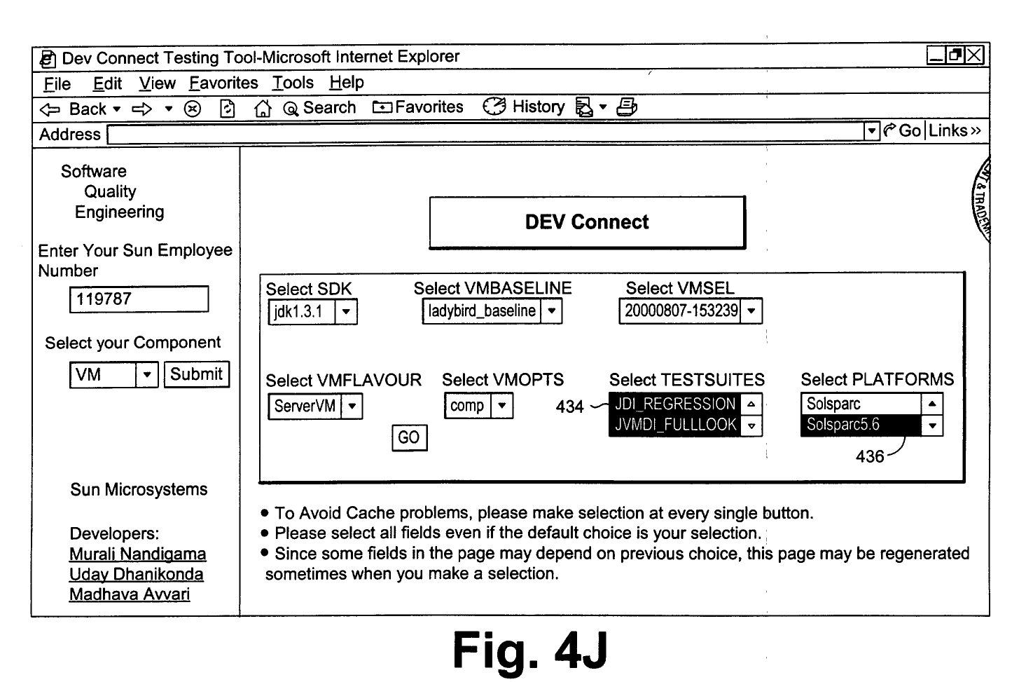

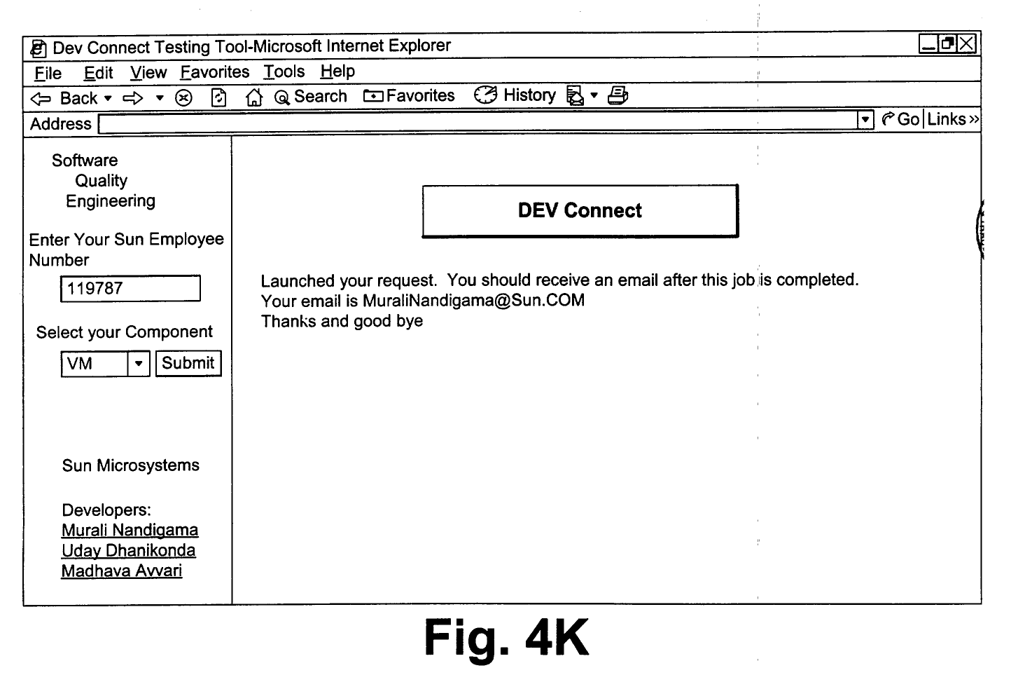

FIG. 4A represents an exemplary main page 400 of a graphical user interface to a distributed testing framework in accordance with one embodiment of the invention. As shown in FIG. 4A, an identification field 402 can be used to request access to the distributed testing framework. In addition, a roll-up window 404 can conveniently be used to select a main testing component (e.g., VM or Virtual Machine). A submit button 406 is also provided to allow the user to submit a request for access to the selected main testing component. Accordingly, a user can use the main page 400 to request access to the distributed testing framework.

If the request to access is not granted, an error page can be displayed. FIG. 4B represents an exemplary error page 410 in accordance with one embodiment of the invention. The error page 410 is displayed when the request to access the distributed testing framework is not granted. On the other hand, when access is granted, a customized test page suitable for the request can be displayed. FIG. 4C represents an exemplary customized test page 420 in accordance with one embodiment of the invention. As will be appreciated, the exemplary test page 420 represents a customized test page for the request submitted by using the main page 400 of FIG. 4A. Furthermore, it should be noted that the customized test page 420 provides test components 422-434. Each of these test components can be implemented as a roll-up window which displays the options that are available for selection.

Referring now to FIG. 4D, the test component 422 is shown as a roll-up window. As will be appreciated, the user can conveniently select a testing option by using the roll-up window. Moreover, when one testing component is selected, other testing components can automatically be updated when it is appropriate. By way of example, when the user selects a value for the testing component 422, the testing component 424 may be updated. In other words, the values displayed in the roll-up window 424 are updated to reflect only those values that are appropriate for the value selected for test component 422.

To illustrate, FIG. 4E shows some values that are appropriate and available for selection for the test component 424 based on the selection made for the test component 422. It should also be noted that making a selection in any one of the test components 422-434 may result in changing the values available for values that are available for selection in one or more of the other test components.

FIGS. 4F-4I illustrate values that can respectively be selected for test component 426-430. Furthermore, FIGS. 4J and 4K illustrate that a test component value, for example, test component 432 can be implemented to allow the user to select two or more values. Accordingly, the user can conveniently select two or more values representing test suites and select one or more platforms to run the test suites by selecting one or more values of the test component 434. As shown in FIG. 4J, a button 436 (“Go” button) is provided to allow the user to submit a request for testing. FIG. 4L illustrates a screen that can be displayed to the user when the request for testing has been launched. As will be appreciated, the user can be notified of the progress of the test. The notifications can, for example, be sent to the user via email.

What is claimed is:

1. A computing environment comprising:
a processing system which includes:
a master system configured to execute a service component and a system controller component,
a processing resource configured to register with a look up service of said service component for a specific period of time, said registering being configured to advertise the eligibility of a processing resource to execute a software processing job having a set of requirements, wherein said system controller component is configured to search a look up service of said service component to locate the processing resource having a set of attributes substantially matching the set of requirements of the software processing job; and
a processing interface capable of communicating with the processing system and providing said processing system with one or more requirements of the set of requirements.

2. A computing environment as recited in claim 1, wherein the processing interface is capable of providing a graphical user interface which can be used to specify said one or more requirements of said set of requirements of the software processing job.

3. A computing environment as recited in claim 1, wherein said processing interface comprises:
an access control module capable of controlling access to the processing system;
a component selector module capable of selecting the one or more requirements;
a graphical user customizer capable of generating a customized graphical user interface based on the selected one or more requirements; the customized graphical user interface displaying only options that are suitable for selecting the one or more requirements; and
a test generator capable of a generating a set of requirements which can be used to locate a processing resource having a set of attributes which substantially match the set of requirements of the software processing job.

4. A computing environment as recited in claim 3, wherein said access control module comprises an authentication module capable of communicating with a database to determine whether a request to access should be granted.

5. A computing environment as recited in claim 3, wherein the processing interface is capable of providing a graphical user interface which can be used to specify said one or more requirements of the set of requirements of the software processing job.

6. A computing environment as recited in claim 1, wherein the system controller component includes:
a communication module configured to manage communication between the system controller component and the processing resource; and
a process management module configured to manage the executing of the software processing job.

7. A computing environment as recited in claim 1, wherein the processing resource has a machine service configured to have a machine service proxy and a set of machine service attributes.

8. A computing environment as recited in claim 1, wherein the machine service is configured to spawn a process service having a process service proxy and a set of process service attributes.

9. A computing environment as recited in claim 1, wherein the process service is configured to have a type substantially similar to the type of the software processing job.

10. A computing environment as recited in claim 1, wherein the process service is configured to register with the look up service implementing the process service proxy and the set of process service attributes.

11. A method of testing a software component in a distributed testing system, wherein said method comprises:
displaying a graphical user interface to said distributed testing system;
receiving a request to test a software component; said request being transmitted through said graphical user interface;
determining whether said graphical user interface should be customized for said request;
customizing said interface based on said request when said determining determines that said interface should be customized for said request; and
displaying said customized interface.

12. A method as recited in claim 11, wherein said method further comprises:
determining whether said request should be allowed.

13. A method as recited in claim 11, wherein said determining of whether said interface should be customized for said request comprises:
determining whether a test component which is displayed within said graphical user interface has been selected;
determining whether said graphical user interface should be updated based on said selected test component; and
updating said interface when said determining determines that said interface should be updated.

14. A method as recited in 11, wherein said updating comprises:
selecting one or more testing components which are appropriate for said selected test component;
displaying said one or more testing components; and
not displaying one or more testing components which were not selected.

15. A method as recited in 13, wherein said method further comprises:
generating a set of requirements which can be used to identify a testing system within said distributed testing system.

16. A computer readable medium including computer program code for a processing interface capable of communicating with a processing system and providing said processing system with one or more requirements of a set of requirements;
wherein said processing system includes:
a master system configured to execute a service component and a system controller component, and
a processing resource configured to register with a look up service of the service component for a specific period of time, the registering being configured to advertise the eligibility of the processing resource to execute a software processing job having a set of requirements, wherein the system controller component is configured to search the look up service of the service component to locate the processing resource having a set of attributes substantially matching the set of requirements of the software processing job.

17. A computer readable medium as recited in claim 16, wherein the processing interface is capable of providing a graphical user interface which can be used to specify said one or more requirements of the set of requirements of the software processing job.

18. A computer readable medium as recited in claim 16, wherein the processing interface comprises:
computer code for an access control module capable of controlling access to the processing system;
computer code for a component selector module capable of selecting the one or more requirements;
computer code for a graphical user customizer capable of generating a customized graphical user interface based on the selected one or more requirements; the customized graphical user interface displaying only options that are suitable for selecting the one or more requirements; and
computer code for a test generator capable of generating a set of requirements which can be used to locate a processing resource having a set of attributes which substantially match the set of requirements of the software processing job.

19. A computer readable medium as recited in claim 16, wherein said processing interface can operate to:
display a graphical user interface to said distributed testing system;
receive a request to test a software component; said request being transmitted through said graphical user interface;
determine whether said graphical user interface should be customized for said request;
customize said interface based on said request when said determining determines that said interface should be customized for said request; and
display said customized interface.
